(19) United States
(12) Patent Application Publication
(10) Pub. No.: US 2004/0170446 A1
(43) Pub. Date: Sep. 2, 2004

(54) Image forming apparatus using a user installable process cartridge, a method of arranging the process cartridge, and the process cartridge itself

(76) Inventors: Hiroyuki Nagashima, Kanagawa-ken (JP); Atsushi Sampe, Kanagawa-ken (JP); Yoshiyuki Kimura, Tokyo (JP); Nobuo Kuwabara, Kanagawa-ken (JP); Hiroshi Hosokawa, Kanagawa-ken (JP); Hideki Zemba, Kanagawa-ken (JP); Wakako Murakami, Tokyo (JP); Yuji Arai, Kanagawa-ken (JP); Satoshi Narumi, Kanagawa-ken (JP); Kiyonori Tsuda, Kanagawa-ken (JP); Ryuta Takeichi, Kanagawa-ken (JP); Masanori Kawasumi, Kanagawa-ken (JP); Kazuhiko Umemura, Shizuoka-ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/740,665

(22) Filed: Dec. 22, 2003

(30) Foreign Application Priority Data
Dec. 20, 2002 (JP) 2002-371154

(51) Int. Cl. G03G 21/16

(52) U.S. Cl. 399/111

(57) ABSTRACT

An image forming apparatus includes a frame, a plurality of process cartridges, and a guide mounted to the frame. The guide mounted to the frame includes a plurality of guide portions having supporting surfaces arranged at predetermined different heights and on which the plurality of process cartridges are detachably placed, and is configured to guide the plurality of process cartridges placed on the supporting surfaces along a path between respective first positions and respective second positions.

### CROSS REFERENCE TO RELATED APPLICATIONS

The present application claims priority under 35 U.S.C. § 119 to Japanese Patent Application No. 2002-371154 filed on Dec. 20, 2002, the entire contents of which is incorporated herein by reference.

### BACKGROUND OF THE INVENTION

1. Field of the Invention

The present invention relates to an image forming apparatus, and more particularly to an image forming apparatus which uses a user installable process cartridge by employing an improved guiding mechanism, and a method of arranging the process cartridge and to the process cartridge itself.

2. Discussion of the Background

Some background color image forming apparatuses use a plurality of process cartridges detachably mountable therein for forming toner images to be superimposed one after another into a full-color image.

Such background color image forming apparatuses are commonly known as electrophotographic copying machines, printing machines, facsimile apparatuses, and multifunctional apparatuses having at least two functions of copying, printing and facsimile functions. An example of the background color image forming apparatuses is described in a reference of Japanese laid-open patent application No. 2002-6679. This background color image forming apparatus uses a process cartridge in which an image bearing member and an image forming mechanism, or at least a portion of the image forming mechanism, are integrally mounted. The process cartridge is removably arranged inside the image forming apparatus, allowing the image bearing member and the image forming mechanism to be checked, repaired and replaced.

Further, in one of these background color image forming apparatuses, a plurality of such process cartridges are arranged serially along an angled plane relative to a horizontal plane.

The background image forming apparatus has a structure in which a slide rail provided to the process cartridge is arranged slidable along a guide rail provided to the image forming apparatus to allow the process cartridge to be removed or inserted.

However, in the background color image forming apparatus using a guiding device that includes such a guide rail and a slide rail, the slide rail needs to be properly engaged with the guide rail such that each process cartridge is installed in the image forming apparatus with a fine positioning. This installation of the process cartridge is difficult for an inexperienced person or a user. Further, the user may be embarrassed because it is difficult for him or her to instantly find a location of the guide rail in the image forming apparatus.

### SUMMARY OF THE INVENTION

One object of the present invention is to provide a novel image forming apparatus that includes a frame, a plurality of process cartridges, and a guide mounted to the frame. The guide includes a plurality of guide portions that have supporting surfaces arranged at predetermined different heights and on which the plurality of process cartridges are detachably placed. Further, the guide is configured to guide the plurality of process cartridges placed on the supporting surfaces along a path between respective first positions and respective second positions.

Another object of the present invention is to provide a novel image forming apparatus that includes a frame, a plurality of process cartridges, and means for holding and for guiding. The plurality of process cartridges are configured to sequentially form color toner images with toners of predetermined colors different from each other to form a full-color image in each image forming cycle. The means for holding and for guiding holds the plurality of process cartridges which are downwardly placed thereto at predetermined different heights and guides the plurality of process cartridges along a path between respective first positions to respective second positions.

Yet another object of the present invention is to provide a novel method of a process cartridge loading arrangement for an image forming apparatus that includes providing a guide that has a plurality of guide portions with supporting surfaces arranged at predetermined different heights, placing a plurality of process cartridges detachably on the supporting surfaces of the plurality of guide portions of the guide, and guiding the plurality of process cartridges placed on the supporting surfaces from respective first positions to respective second positions.

Another object of the present invention is to provide a novel detachable process cartridge for an image forming apparatus that includes a bottom that has an approximately plane surface held in contact by a supporting member of the image forming apparatus, and a side surface that includes an engaging portion configured to engage with a guide of the image forming apparatus.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 illustrates a vertical sectional view of a full-color image forming apparatus according to an embodiment of the present invention;

FIG. 2 illustrates an enlarged sectional view of an image bearing member and an image forming mechanism arranged around the image bearing member;

FIG. 3 illustrates a sectional view of a guide having guide portions arranged in a stepped manner;

FIG. 4 illustrates a process cartridge provided with a guide groove engaged with the guide protrusion;

FIG. 5 illustrates a perspective view of the image forming apparatus of FIG. 1 with a cover plate opened, the cover plate being provided to a front side of the image forming apparatus;

FIG. 6 illustrates a vertical sectional view of an image forming apparatus according to another embodiment of the present invention;

FIG. 7 illustrates a perspective view in part of the image forming apparatus of FIG. 6 showing an inside of the image forming apparatus with the process cartridges removed;

FIG. 8 illustrates an enlarged view of a guide portion of the image forming apparatus of FIG. 6;

FIG. 9 illustrates a perspective view in part of a process cartridge with a lever positioned at a release position at which the process cartridge is released from the guide portion;

FIG. 10 illustrates a side view of the process cartridge with the lever at a locking position at which the process cartridge is locked to the guide portion;

FIG. 11 illustrates a perspective view of the process cartridge from a rear side; and

FIG. 12 illustrates an enlarged view in part of the process cartridge from the rear side.

### DETAILED DESCRIPTION OF THE PREFERRED EMBODIMENTS

Referring now to the drawings, wherein like reference numerals designate identical or corresponding parts throughout the several views, preferred embodiments of the present invention are described.

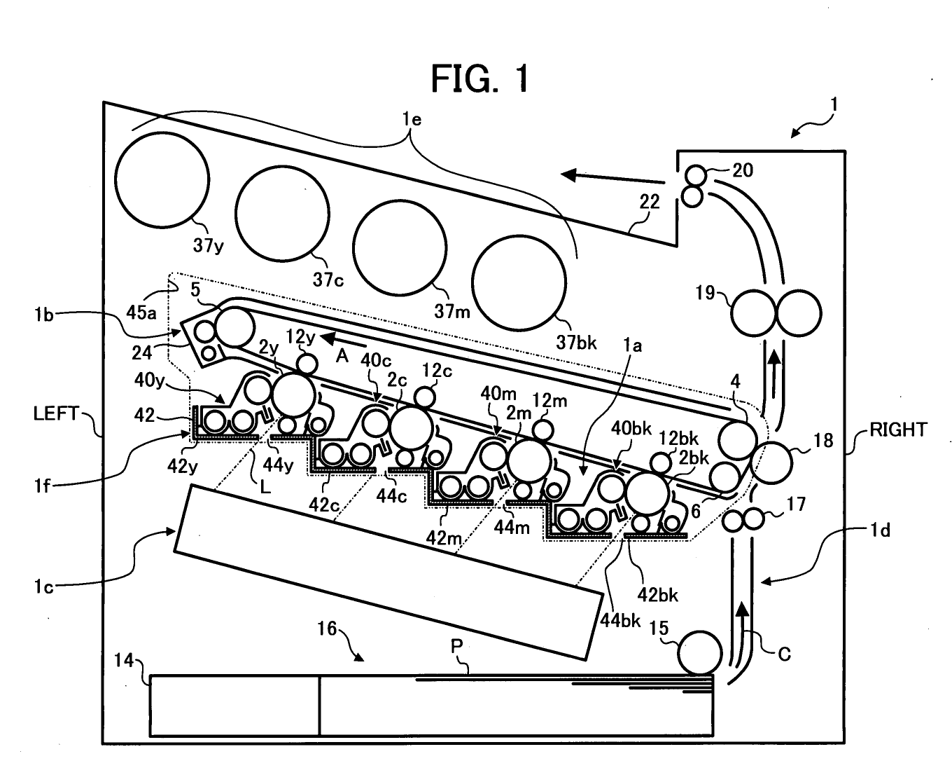

Referring to FIG. 1, an image forming apparatus 1 is shown that includes an image forming mechanism 1a, a transfer medium 1b, an optical writing system 1c, a sheet feeding mechanism 1d, a toner feeding mechanism 1e, and a guiding mechanism 1f.

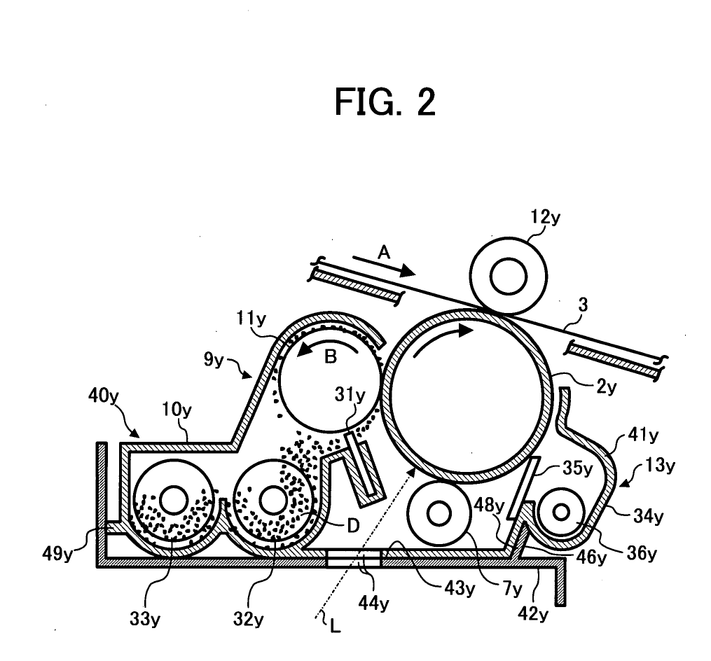

The image forming mechanism 1a generally includes four process cartridges 40y, 40c, 40m and 40bk which are explained with reference to FIG. 2. FIG. 2 illustrates an enlarged sectional view of the process cartridge 40y, focusing on operations of the process cartridge 40y. The process cartridges 40y, 40c, 40m and 40bk have identical structures with toners of different colors. The process cartridge 40y includes an image bearing member 2yand various image forming components including a charging roller 7y, a developing unit 9yand a cleaning unit 13y. The developing unit 9y includes a developing roller 11y, a developing blade 31y, and toner conveying screws 32y and 33y. The parts of the developing unit 9y are encased in a developing case 10y that contains a dry-type developer D. The cleaning unit 13y includes a cleaning blade 35y and a collected-toner conveying screw 36y. The parts of the cleaning unit 13y are encased in a cleaning case 34y. According to the image forming apparatus 1 of the present invention, the developing case 10y and the cleaning case 34y are integrally mounted to form a unit case 41y. The unit case 41y has a light passing window 44y at the bottom thereof.

The transfer medium 1b includes an intermediate transfer belt 3. The intermediate transfer belt 3 is supported by a plurality of supporting rollers 4, 5 and 6, and is held in contact with primary transfer rollers 12y, 12c, 12m and 12bk which correspond to the image bearing members 2y, 2c, 2m and 2bk, respectively.

The optical writing system 1c includes an optical writing device.

The sheet feeding mechanism 1d includes a sheet feeding cassette 14, a sheet feeding roller 15, a sheet feeding unit 16, a registration roller pair 17, a secondary transfer roller 18, a fixing unit 19, a sheet discharging roller pair 20, a sheet discharging part 22 and a belt cleaning unit 24.

The toner feeding mechanism 1e includes toner bottles 37y, 37c, 37m and 37bk.

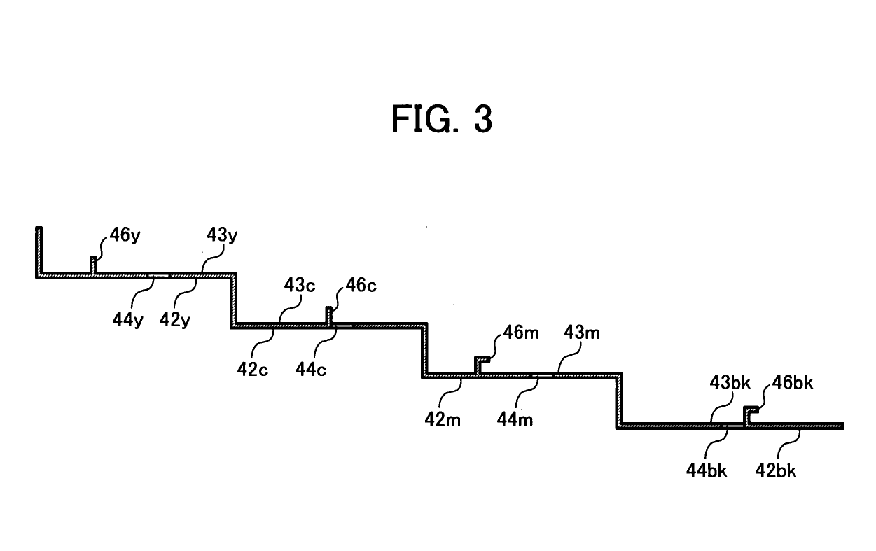

The guiding mechanism 1f includes a guide 42 having guide portions 42y, 42c, 42m and 42bk which are explained with reference to FIG. 3. The guide portions 42y, 42c, 42m and 42bk have supporting surfaces 43y, 43c, 43m and 43bk, and guide protrusions 46y, 46c, 46m and 46bk, respectively.

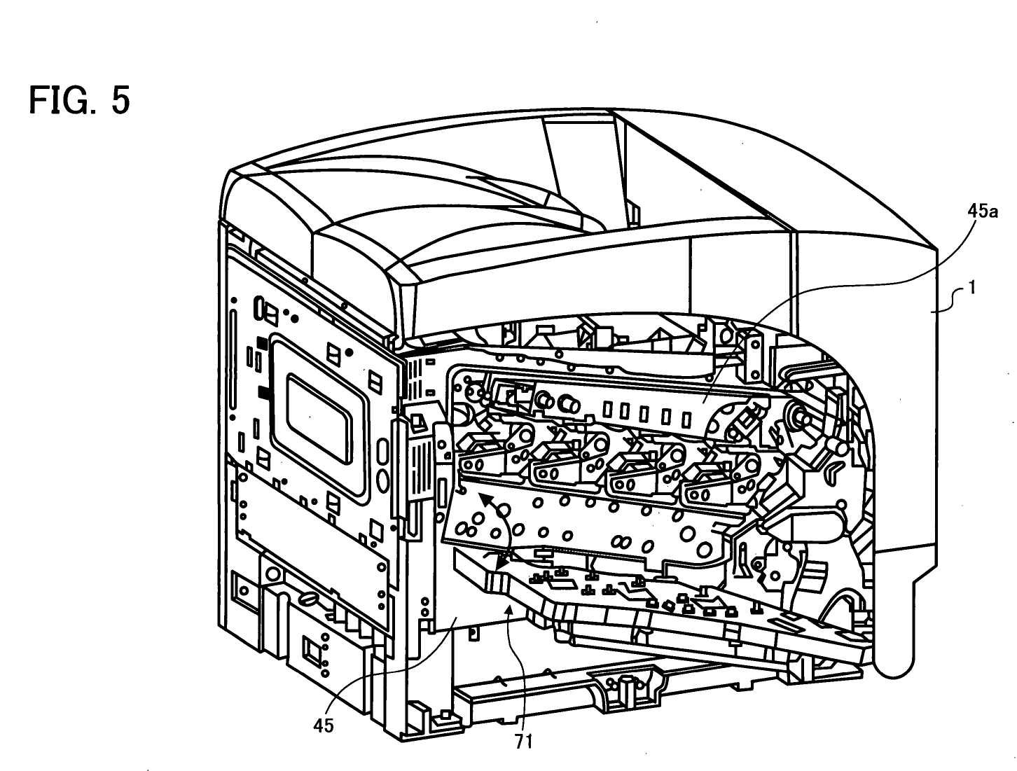

The image forming apparatus 1 of the present invention also includes an opening 45a (shown in FIG. 5) on a front side panel thereof.

The intermediate transfer belt 3 is arranged above the image forming mechanism 1a at a predetermined angle relative to the horizontal plane with one end of the intermediate transfer belt 3 close to the supporting roller 5 higher than the other end thereof. The predetermined angle is preferably in a range from approximately 10 degrees to approximately 20 degrees, and is preferably approximately 15 degrees.

The image forming apparatus 1 produces a full-color image through the following operations. The optical writing system 1c emits laser beams to the image forming mechanism 1a supported by the guiding mechanism 1f. The image forming mechanism 1a produces different color images with toners which are conveyed by the toner feeding mechanism 1e, and transfers the images one after another onto the transfer medium 1b to form a superimposed full-color image. The transfer medium 1b then transfers the superimposed full-color image onto a recording medium fed by the sheet feeding mechanism 1d. The full-color image transferred onto the recording medium 1b is fixed and then discharged onto the top of the image forming apparatus 1.

Referring to FIG. 2, operations of the image forming mechanism 1a are explained. As previously described, the process cartridges 40y, 40c, 40m and 40bk have identical structures. Therefore, an explanation will be given focusing on the operations performed by the process cartridge 40y.

The image bearing member 2y has a drum-shaped photoconductive element and forms an electrostatic latent image for a single color toner image on its surface. The image forming components are arranged around the image bearing member 2y and form the single color toner image based on the electrostatic latent image formed on the image bearing member 2y.

The image bearing member 2y rotates clockwise. The charging roller 7y is applied with a charged voltage and then charges the image bearing member 2y to a predetermined polarity to form an electrostatic latent image on the image bearing member 2y. The optical writing system 1c emits and irradiates the image bearing member 2y with a laser beam L.

The developing unit 9y visualizes the electrostatic latent image as a yellow toner image. The developing roller 11y is rotatably supported by the developing case 10y and is closely placed opposite to the image bearing member 2y through an open space formed on the developing case 10y. The developing blade 31y regulates an amount of the dry-type developer D on the developing roller 11y. The toner conveying screws 32y and 33y are oppositely provided to the developing roller 11y. The dry-type developer D in the developing case 10y is agitated by the toner conveying screws 32y and 33y, carried onto a surface of the developing roller 11y, and then conveyed by the developing roller 11y rotating in a direction B, as indicated in FIG. 2. The developing blade 31 y regulates the dry-type developer D accumulated on the surface of the developing roller 11y to a fixed level. The dry-type developer D of the regulated amount adhering on the developing roller 11y is conveyed to a developing area formed between the developing roller 11y and the image bearing member 2y. In the developing area, toner contained in the dry-type developer D is electrostatically transferred onto an electrostatic latent image formed on the surface of the image bearing member 2y such that the electrostatic latent image becomes visualized as a toner image. The dry-type developer D may be a one-component developer or a two-component developer. The present invention preferably uses the two-component developer including toner and carriers.

As shown in FIG. 1, the intermediate transfer belt 3 that serves as the transfer medium 1b forms an endless belt extended with pressure among the plurality of supporting rollers 4, 5 and 6, and rotates in a direction A. The intermediate transfer belt 3 is arranged with an angle to a horizontal plane in an obliquely downward direction from left (LEFT) to right (RIGHT) of the image forming apparatus 1 in FIG. 1. The intermediate transfer belt 3 is held in contact between the primary transfer roller 12y arranged at a position opposite to the image bearing member 2y such that the toner image formed on the surface of the image bearing member 2y is transferred onto the intermediate transfer belt 3 to superimpose different color toner images to obtain a recorded image. The primary transfer roller 12y receives a transfer voltage and primarily transfers a yellow toner image onto the surface of the intermediate transfer belt 3 by an action of the transfer voltage.

As shown in FIG. 2, after the yellow toner image is transferred onto the intermediate transfer belt 3, the cleaning unit 13y scrapes the surface of the image bearing member 2y to remove residual toner adhering to the surface of the image bearing member 2y.

The cleaning unit 13y is encased by the cleaning case 34y that has an opening relative to the image bearing member 2y. The cleaning blade 35y has a base edge fixedly supported by the cleaning case 34y and a leading edge pressed onto the surface of the image bearing member 2y to scrape the residual toner adhering to the surface of the image bearing member 2y. The collected-toner conveying screw 36y conveys removed toner to a toner collecting bottle (not shown).

The charging roller 7y is applied a voltage generated by a current that includes a direct current and a superimposed alternating current. The charging roller 7y simultaneously discharges and charges the surface of the image bearing member 2y with the voltage applied. Namely, the image bearing member 2y is prepared for a next image forming operation. Thus, a yellow toner image is formed on the image bearing member 2y and is transferred onto the intermediate transfer belt 3.

Through operations similar to those as described above, a cyan toner image, a magenta toner image and a black toner image are formed on the surfaces of the image bearing members 2c, 2m and 2bk, respectively. Those color toner images are sequentially superimposed on the surface of the intermediate transfer belt 3 on which the yellow toner image is already formed, such that a primary superimposed toner image is formed on the intermediate transfer belt 3. After the toner images in the different colors are transferred, residual toner on the image bearing members 2c, 2m and 2bk is also removed by the cleaning units 13c, 13m and 13bk, respectively. As shown in FIG. 1, the image forming components have the same numbers as those corresponding to and arranged around the image bearing member 2y, with respective characters “c”, “m” and “bk” according to their respective colors.

As shown in FIG. 1, the sheet feeding mechanism 1d is arranged at the lower part of the image forming apparatus 1. The sheet feeding cassette 14 accommodates a plurality of recording media such as transfer sheets that include a recording medium P. The sheet feeding roller 15 is provided at the top of the sheet feeding unit 16 and feeds recording media. When the sheet feeding roller 15 is rotated, the recording medium P, placed on the top of a sheet stack of recording media in the sheet feeding cassette 14, is fed in a direction C as indicated in FIG. 1. The recording medium P, fed from the sheet feeding cassette 14, is conveyed to the registration roller pair 17. The registration roller pair 17 stops and feeds the recording medium P in synchronization with a movement of the superimposed toner image towards a transfer area formed between the intermediate transfer belt 3 and the secondary transfer roller 18. The secondary transfer roller 18 is applied with an adequate predetermined transfer voltage such that a primary superimposed toner image, formed on the surface of the intermediate transfer belt 3, is transferred onto the recording medium P to form a secondary superimposed toner image.

The recording medium P that has the secondary superimposed toner image thereon is conveyed further upward and passes between a pair of fixing rollers of the fixing unit 19. The fixing unit 19 fixes the secondary superimposed toner image to the recording medium P by applying heat and pressure. After the recording medium P passes the fixing unit 19, the recording medium P is discharged face-down by the sheet discharging roller pair 20 to the sheet discharging part 22 provided at the upper portion of the image forming apparatus 1. The belt cleaning unit 24 scrapes the surface of the intermediate belt 3 and removes residual toner adhering onto the surface of the intermediate transfer belt 3.

As shown in FIG. 1, the toner bottles 37y, 37c, 37m and 37bk of the toner feeding mechanism 1e are provided at the upper portion of the image forming apparatus 1 and contain yellow, cyan, magenta and black toners, respectively. Yellow, cyan, magenta and black toners are conveyed from the toner bottles 37y, 37c, 37m and 37bk, respectively, through respective conveying paths (not shown) to supply the developing units 9y, 9c, 9m and 9bk, respectively.

As previously described, a process cartridge (40y, 40c, 40m and 40bk) is formed by an image bearing member (2y, 2c, 2m and 2bk) and at least a part of the image forming mechanism 1a. The image bearing member (2y, 2c, 2m and 2bk) has a surface on which an electrostatic latent image for a corresponding color out of predetermined colors is formed. The image forming mechanism 1a is integrally mounted with the image bearing member (2y, 2c, 2m and 2bk). The image forming mechanism 1a is configured to form a toner image in a corresponding color based on the electrostatic latent image formed on the image bearing member (2y, 2c, 2m and 2bk). The image forming apparatus 1 includes a plurality of process cartridges (40y, 40c, 40m and 40bk) configured to transfer yellow, cyan, magenta and black toner images, respectively, formed on the image bearing members 2y, 2c, 2m and 2bk, respectively, into a full-color toner image onto the intermediate transfer belt 3. More specifically, in the process cartridge 40y, the developing case lOy and the cleaning case 34y are integrally formed as a unit case 41y, as shown in FIG. 2. The image bearing member 2y is rotatably supported by the unit case 41y. The image bearing member 2y, developing unit 9y, cleaning unit 13yand charging roller 7y are integrally mounted to form process cartridge 40y. As previously described, the process cartridge does not necessarily include an entire portion of the image forming mechanism. The process cartridge may include the image bearing member and at least one of the charging unit, the developing unit and the cleaning unit.

The image bearing members 2y, 2c, 2m and 2bk are in contact with a bottom surface of the intermediate transfer belt 3 between the supporting rollers 5 and 6, and are arranged such that the supporting roller 5 is disposed higher than the supporting roller 6. As shown in FIG. 1, the process cartridges 40y, 40c, 40m and 40bk may be removed in an axial direction of the image bearing members 2y, 2c, 2m and 2bk, respectively.

FIG. 3 illustrates a sectional view of the guide 42 including the guide portions 42y, 42c, 42m and 42bk arranged in a stepped manner, according to an embodiment of the present invention. The guide 42 includes the guide portions 42y, 42c, 42m and 42bk, and is fixed to the image forming apparatus 1. The supporting surfaces 43y, 43c, 43m and 43bk are mounted substantially horizontal and have respective bottom and side surfaces for supporting the process cartridges 40y, 40c, 40m and 40bk. The supporting surfaces 43y, 43c, 43m and 43bk guide the process cartridges 40y, 40c, 40m and 40bk when the process cartridges 40y, 40c, 40m and 40bk are inserted into or removed from the image forming apparatus 1. The supporting surfaces 43y, 43c, 43m and 43bk guide the process cartridges 40y, 40c, 40m and 40bk, respectively, and are arranged at positions having different heights in a stepped manner according to heights of positions of the process cartridges 40y, 40c, 40m and 40bk. The guide portions 42y, 42c, 42m and 42bk of the guide 42 support the process cartridges 40y, 40c, 40m and 40bk, and have a predetermined angle to the horizontal plane and are arranged parallel to the intermediate transfer belt 3. The guide portions 42y, 42c, 42m and 42bk and the unit cases 41y, 41c, 41m and 41bk of the process cartridges 40y, 40c, 40m and 40bk include the light passing windows 44y, 44c, 44m and 44bk, respectively, for passing a laser beam L emitted by the optical writing system 1c to the image bearing members 2y, 2c, 2m and 2bk, respectively.

Further, as shown in FIG. 2, the developing case 10y includes a convex portion 49y in the vicinity of the toner conveying screw 33y such that the process cartridge 40y is guided along a vertical side of the guide portion 42y. The other developing cases 10c, 10m and 10bk are arranged in a similar manner. Accordingly, the vertical side of the guide portion 42y is also used as a guide member for the process cartridge 40y.

The image forming apparatus 1 includes an internal front panel 45 (see FIG. 5) disposed over an internal front side of the image forming apparatus 1 (the surface side of the figure). The internal front side panel 45 covers the internal portions of the image forming apparatus 1 including the process cartridges 40y, 40c, 40m and 40bk, the intermediate transfer belt 3, and the optical writing system 1c. The internal front panel 45 has an opening 45a formed as indicated by the chain double-dashed lines shown in FIG. 1. The process cartridges 40y, 40c, 40m and 40bk are removable through the opening 45a. Further, the image forming apparatus 1 includes a cover plate 71 which is hingedly mounted to the internal front panel 45 to cover the opening 45a. The cover plate 71 may be opened and closed, and has a shape for determining precision positions of the process cartridges 10y, 40c, 40m and 40bk. For instance, holes may be used for determining precision positions of the process cartridges 40y, 40c, 40m and 40bk. When the cover plate 71 is set to a closed position, an engaging mechanism (not shown) completely fixes positions of the image bearing members of the process cartridges to perform the image forming operation. FIG. 5 illustrates a perspective view of the image forming apparatus 1 and shows a relationship between the opening 45a and the cover plate 71.

According to this configuration, when the process cartridge 40y is checked, repaired or replaced, a user may pull the process cartridge 40y in a direction towards the user to detach it from the supporting surface 43y. The user may place and push the process cartridge 40y on the supporting surface 43y in a reverse direction to attach it. Namely, the user may remove and insert the process cartridge while keeping it horizontal. Therefore, there is no need to engage the slide rail provided on the process cartridge with the guide rail provided on the image forming apparatus. Further, by opening the cover plate 71 of the image forming apparatus 1, the user may instantly recognize the position of the supporting surface 43y and understand that the supporting surface 43y may be used to guide the process cartridge 40y when the process cartridge 40y is inserted or removed. Thus, even an inexperienced user may easily attach and detach the process cartridge 40y while keeping it horizontal. This process may also be applied to the other process cartridges 40c, 40m and 40bk.

Further, the image forming apparatus 1 includes a regulating member configured to regulate a path of the process cartridge. The regulating member prevents the process cartridge from undesirable movements in a direction perpendicular to the path of the process cartridge along the plane of the supporting surface of the guide during attachment and detachment. Thus, the process cartridge does not cause interference and damage to another process cartridge placed next to it. As shown in FIG. 2, the guide portion 42y includes the regulating member that has a guide protrusion 46y protruding upward from the supporting surface 43y of the guide portion 42y and extending toward a removing direction of the process cartridge 40y. The guide protrusion 46y may be slidably engaged in a groove 48y formed on the unit case 41y of the process cartridge 40y to prevent the process cartridge 40y from undesirable movements in a direction perpendicular to the path of the process cartridge 40y during attachment and detachment. Alternatively, the process cartridge 40y may include the guide protrusion 46y and the supporting surface 43y may include the groove 48y. The processes described above relating to the yellow toner as indicated by the character “y” may also be applied to parts and units related to the cyan, magenta and black toners as indicated by the characters “c”, “m” and “bk”.

In FIG. 3, the guide portions 42y, 42c, 42m, and 42bk may include the guiding protrusions 46y, 46c, 46m, and 46bk, and may have different shapes and mounting locations to properly engage respective grooves included in the process cartridges 40y, 40c, 40m, and 40bk.

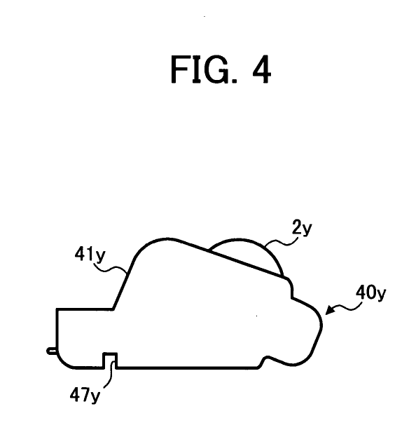

FIG. 4 shows an illustration of the unit case 41y of the process cartridge 40y that has a guide groove 47y thereon. The unit case 41y of the process cartridge 40y includes the guide groove 47y which may be engaged with the guide protrusion 46y included in the guide portion 44y close to the vertical side of the guide portion 44y, as shown in FIG. 3. Improper insertion of the process cartridges may be prevented by varying the form or the locations of the guide protrusions and the guide grooves. Alternatively, the guide portions 42y, 42c, 42m and 42bk may include the guide grooves 47y, 47c, 47m and 47bk and the process cartridges 40y, 40c, 40m and 40bk may include the guide protrusions 46y, 46c, 46m, and 46bk such that the process cartridges 40y, 40c, 40m and 40bk are prevented from being misaligned. Thus, an improper insertion of process cartridge may also be prevented. An erroneous supply of improper color toner to a developing unit may also be prevented. As a result, the quality deterioration of the image due to color toner mixture is avoided.

Further, the image forming apparatus 1 includes an elevating member (not shown) which allows the guide portions 42y, 42c, 42m and 42bk to move vertically. When detaching the process cartridges 40y, 40c, 40m and 40bk, the elevating member descends the guide portions 42y, 42c, 42m and 42bk supporting the process cartridges 40y, 40c, 40m and 40bk such that the image bearing members 2y, 2c, 2m and 2bk separate from the intermediate transfer belt 3. The separation avoids rubbing and damaging the surfaces of the image bearing members 2y, 2c, 2m and 2bk, and the surface of the intermediate transfer belt 3. The guide portions 42y, 42c, 42m and 42bk may be configured to elevate collectively or individually. If the guide portions 42y, 42c, 42m and 42bk are individually movable, a user can selectively descend the guide portions 42y, 42c, 42m and 42bk to attach or detach a desired process cartridge.

Alternatively, the intermediate transfer belt 3 may be eliminated with the images directly transferred onto a recording paper sheet.

As shown in FIG. 1, the image forming apparatus 1 includes toner bottles 37y, 37c, 37m and 37bk which are separately mounted to the process cartridges 40y, 40c, 40m and 40bk, respectively. The toner bottles 37y, 37c, 37m and 37bk of different colors are provided above the intermediate transfer belt 3 and correspond to the process cartridges 40y, 40c, 40m and 40bk, respectively, such that each color toner is conveyed to a corresponding one of the process cartridges 40y, 40c, 40m and 40bk. The toner bottles 37y, 37c, 37m and 37bk may be replaced separately from the process cartridges 40y, 40c, 40m and 40bk when a toner needs to be replenished. Also, the process cartridges 40y, 40c, 40m and 40bk may be replaced separately from the toner bottles 37y, 37c, 37m and 37bk when a component needs to be replaced. Thus, this structure allows separate exchanges of toner and process cartridges, thereby reducing the maintenance cost for the user. Therefore, the number of opening and closing operations of the cover plate 71 may be reduced and the number of replacements of the process cartridges may also be reduced. Thereby, toner scattering in an area such as a shutter area may be prevented and operator-maintainability is improved.

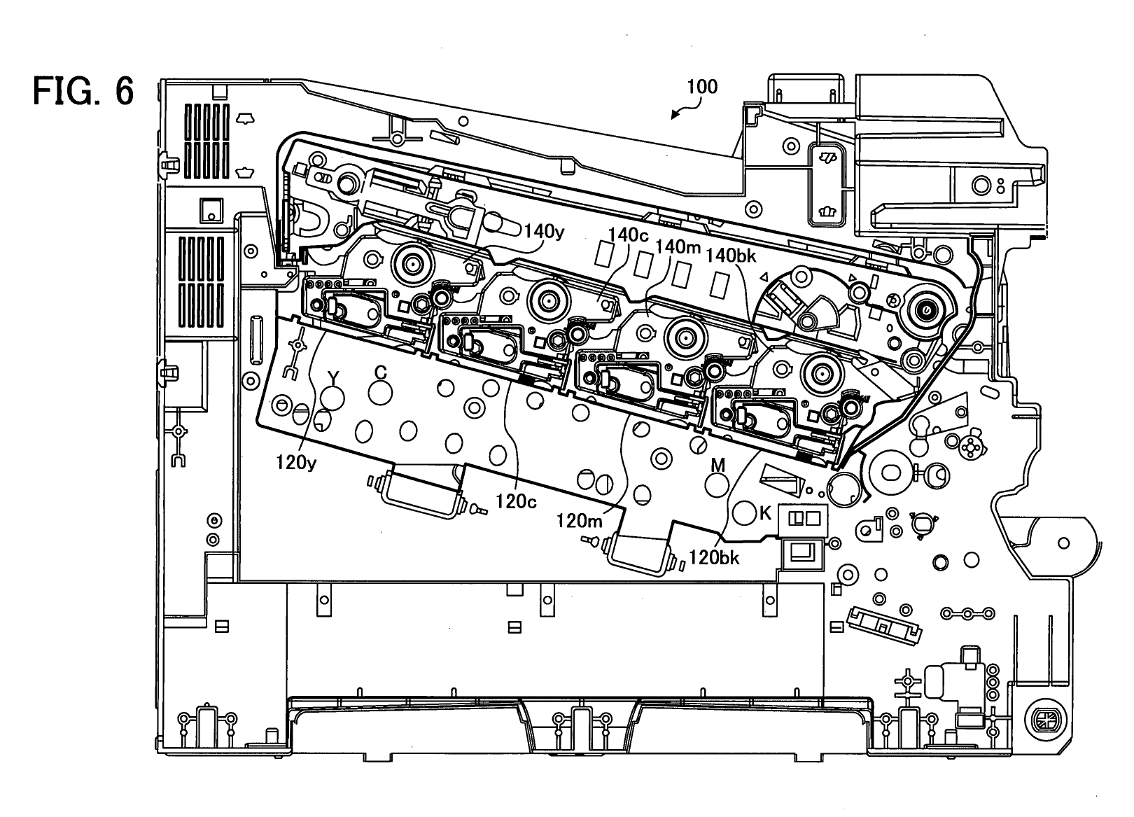

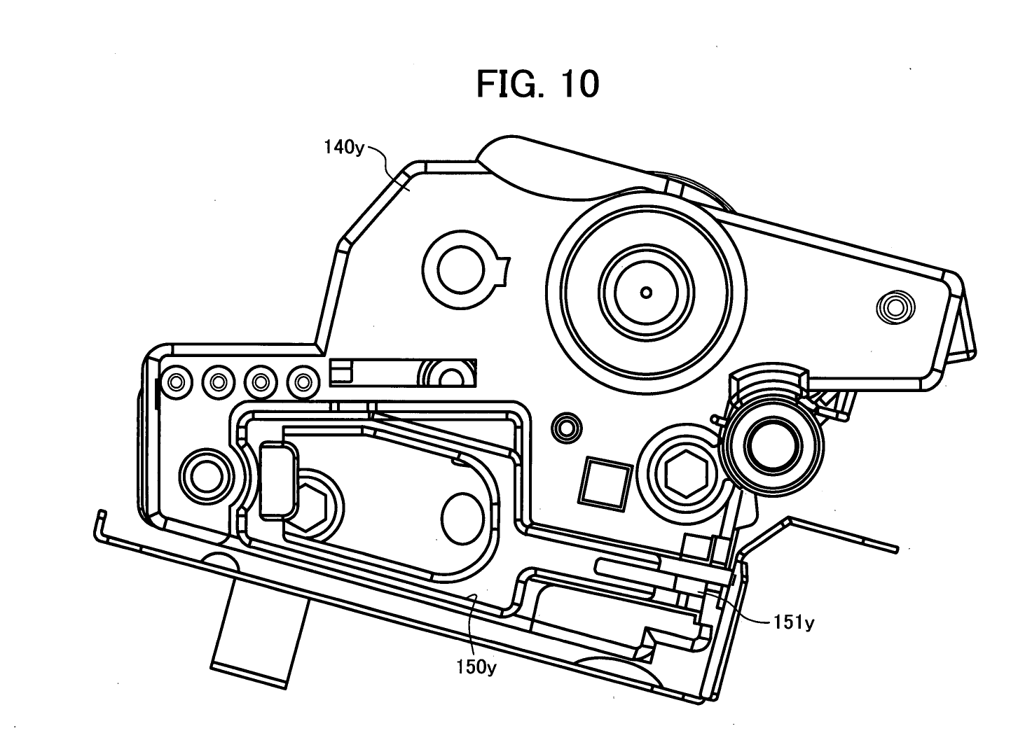

Next, an image forming apparatus 100 according to another embodiment of the present invention is described with reference to FIGS. 6 through 12. FIG. 6 shows an image forming apparatus 100 that includes guide portions 120y, 120c, 120m and 120bk and process cartridges 140y, 140c, 140m and 140bk. The image forming apparatus 100 is similar to the image forming apparatus 1 of FIG. 1.

In the discussion following, suffix characters “y”,“c”,“m” and “bk” are attached to reference numbers of components and represent respective colors. Based on this suffix system, the following explanation primarily focuses on the yellow color mechanism section. The remaining color mechanism sections have similar structures.

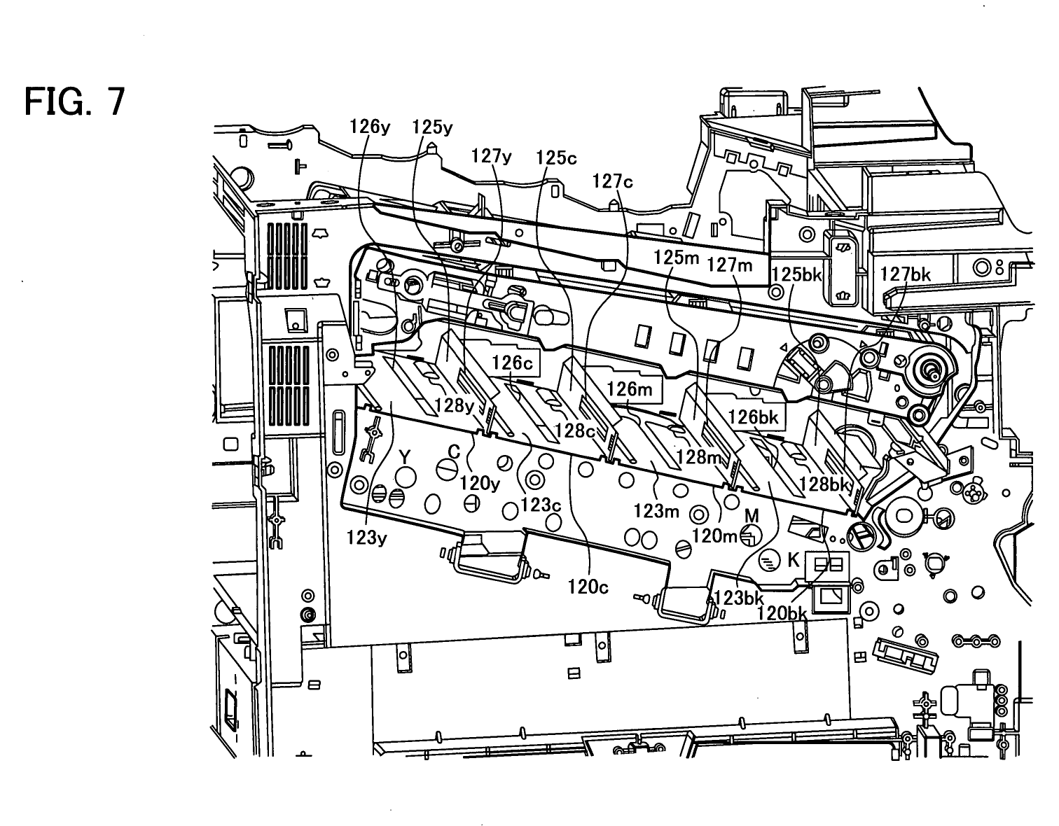

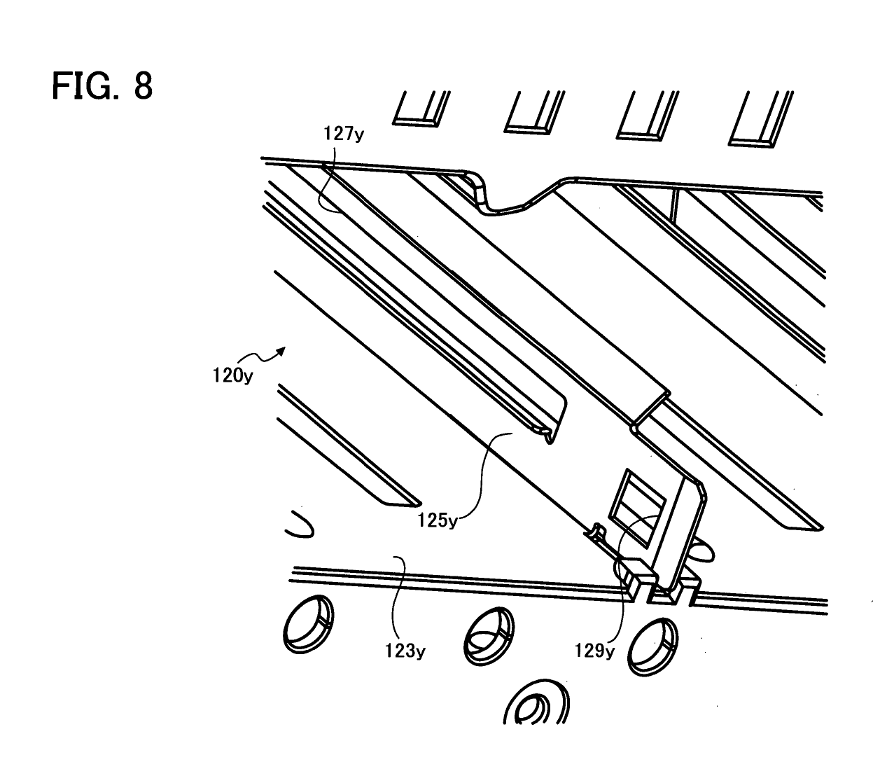

As shown in FIG. 7, the guide portions 120y, 120c, 120m and 120bk of the image forming apparatus 100 include supporting surfaces 123y, 123c, 123m and 123bk, and regulating members 125y, 125c, 125m and 125bk. The supporting surfaces 123y, 123c, 123m and 123bk include light passing windows 126y, 126c, 126m and 126bk, and pushup members 128y, 128c, 128m and 128bk. The regulating members 125y, 125c, 125m and 125bk include guide openings 127y, 127c, 127m and 127bk. FIG. 8 illustrates a positioning hole 129y of the regulating member 125y.

Further, while each of the supporting surfaces 43y, 43c, 43m and 43bk of a corresponding one of the guide portions 42y, 42c, 42m and 42bk is arranged approximately horizontal in the image forming apparatus 1, each of the supporting surfaces 123y, 123c, 123m and 123bk of a corresponding one of the guide portions 120y, 120c, 120m and 120bk is arranged to be inclined relative to a horizontal plane in the image forming apparatus 100.

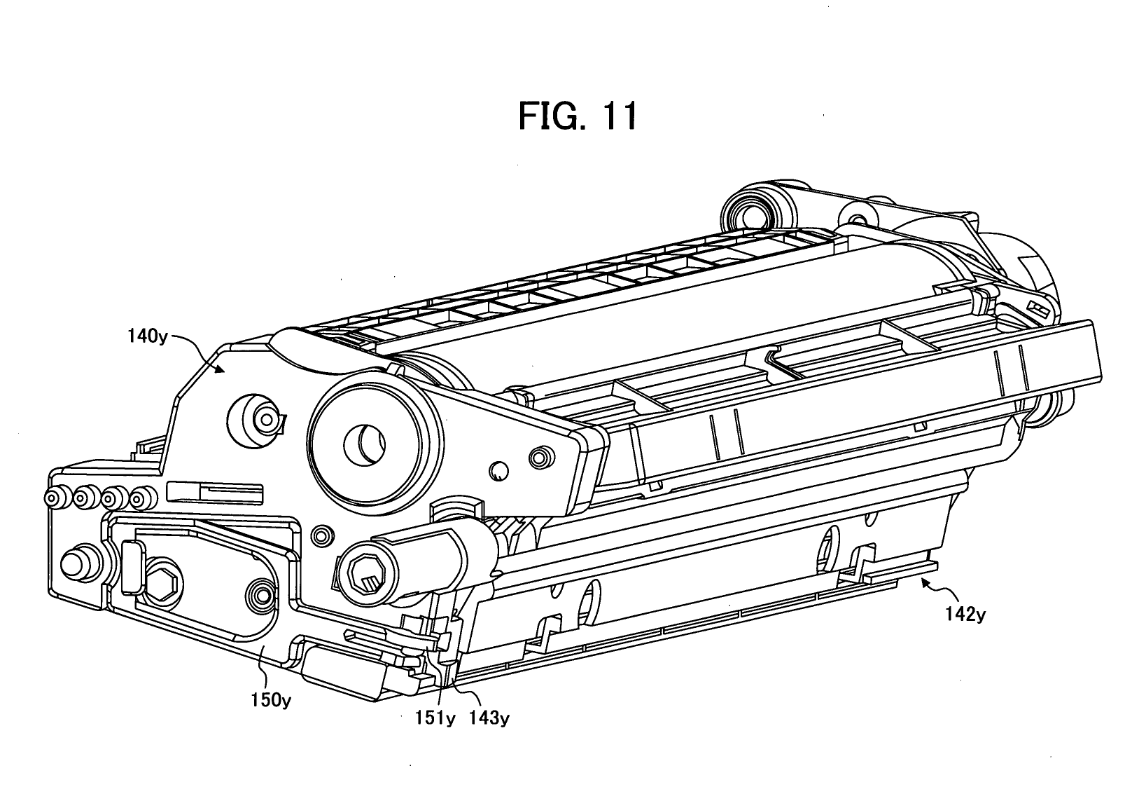

The process cartridges 140y, 140c, 140m and 140bk of the image forming apparatus 100, shown in FIG. 6, are similar to the process cartridges 40y, 40c, 40m and 40bk, respectively, of the image forming apparatus 1, shown in FIG. 1, with the exception of the guide portion 120y, for example, a convex portion 142y, a positioning latch 143y, a lever 150y, and a cam 151y, as shown in FIG. 11.

This structure allows a sliding movement of each of the process cartridges 140y, 140c, 140m and 140bk in a stable manner. More specifically, the process cartridge 140y slidably moves on the guide portion 120y while pressing down both the supporting surface 123y and the regulating member 125y by its own weight, thereby avoiding undesirable movements of the process cartridge 140y in a direction parallel to the supporting surface 123y.

Detailed structures of the guide portions 120y, 120c, 120m and 120bk and the process cartridges 140y, 140c, 140m and 140bk different from those of the guide portions 42y, 42c, 42m and 42bk, and the process cartridges 40y, 40c, 40m and 40bk are now described.

FIG. 7 shows the inside of the image forming apparatus 100 when the process cartridges 140y, 140c, 140m and 140bk are removed. Each of the guide portions 120y, 120c, 120m and 120bk has an L-shaped form. The supporting surfaces 123y, 123c, 123m and 123bk support the bottom surfaces of the process cartridges 140y, 140c, 140m and 140bk, respectively. The light passing windows 126y, 126c, 126m and 126bk are included in the supporting surfaces 123y, 123c, 123m and 123bk, respectively. Each of the light passing windows 126y, 126c, 126m and 126bk passes a laser beam emitted by an optical writing system which is positioned under the guide portions 120y, 120c, 120m and 120bk. The supporting surfaces 123y, 123c, 123m and 123bk include pushup members 128y, 128c, 128mand 128bk, respectively. The pushup members 128y, 128c, 128m and 128bk guide the process cartridges 140y, 140c, 140m and 140bk, respectively, such that the process cartridges 140y, 140c, 140m and 140bk are pushed up to positions contacting the intermediate transfer belt. The regulating members 125y, 125c, 125m and 125bk are arranged approximately perpendicular to the supporting surfaces 123y, 123c, 123m and 123bk, respectively. The regulating members 125y, 125c, 125m and 125bk regulate movement of the process cartridges 140y, 140c, 140m and 140bk, respectively, to precision positions. The regulating members 125y, 125c, 125m and 125bk include guide openings 127y, 127c, 127m and 127bk and positioning holes 129y, 129c, 129m and 129bk, respectively. Each of the guide openings 127y, 127c, 127m and 127bk guides a corresponding one of the process cartridges 140y, 140c, 140m and 140bk. Each of the positioning holes 129y, 129c, 129m and 129bk is positioned at one edge side of the regulating member close to the cover plate 71, and determines a preliminary operable position of a corresponding one of the process cartridges 140y, 140c, 140m and 140bk, respectively.

Referring to FIGS. 8 through 12, the guide portion 120y and the process cartridge 140y are primarily shown. The guide portions 120y, 120c, 120m and 120bk have identical structures. The process cartridges 140y, 140c, 140m and 140bk also have identical structures with toners different in colors from each other.

FIG. 8 shows an enlarged view of the guide portion 120y. When the process cartridge 140y is slid on the angled supporting surface 123y, the process cartridge 140y presses by its own weight the supporting surface 123y such that undesirable movements in a direction different from the sliding direction are eliminated. The convex portion 142y, shown in FIG. 11, is included at a leading portion of the process cartridge 140y and is configured to be engaged with the guide opening 127y formed on the regulating member 125y of the guide portion 120y. This regulates movements of the process cartridge 140y towards the intermediate transfer belt such that the process cartridge 140y may maintain a distance from the intermediate transfer belt. This prevents damage to a photoconductive drum of the process cartridge 140y and the intermediate transfer belt. When the process cartridge 140y is inserted into the image forming apparatus 100 a certain distance corresponding to a predetermined length of the guide portion 120y, the convex portion 142y of the process cartridge 140y moves off the guide opening 127y. Then, as the process cartridge 140y is inserted, the process cartridge 140y is lifted in a vertical direction by and onto the pushup member 128y of the supporting surface 123y. As a result, the photoconductive drum of the process cartridge 140y contacts the intermediate transfer belt.

To avoid damage to the intermediate transfer belt, the process cartridge 140y is preferably separated from the intermediate transfer belt when the process cartridge 140y is installed. However, the process cartridge 140y needs to be set to a predetermined preliminary position and held in contact with the intermediate transfer belt to perform the image forming operation. As previously described, when the process cartridge 140y is inserted into the image forming apparatus 100, it is guided by the guide opening 127y of the regulating member 125y and the pushup member 128y of the supporting surface 123y. At the preliminary position, the positioning latch 143y of the process cartridge 140y is detented into the positioning hole 129y of the guide portion 120y such that the positioning latch 143y and the positioning hole 129y are engaged to determine the preliminary position of the process cartridge 140y. The process cartridge 140y located at the preliminary position is fixed to a precision position by closing the cover plate 71.

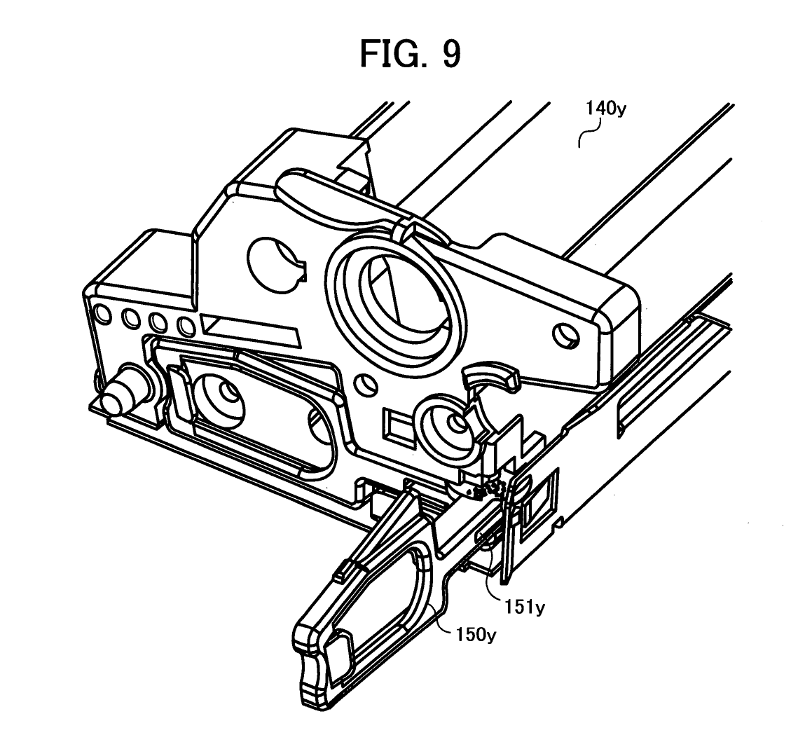

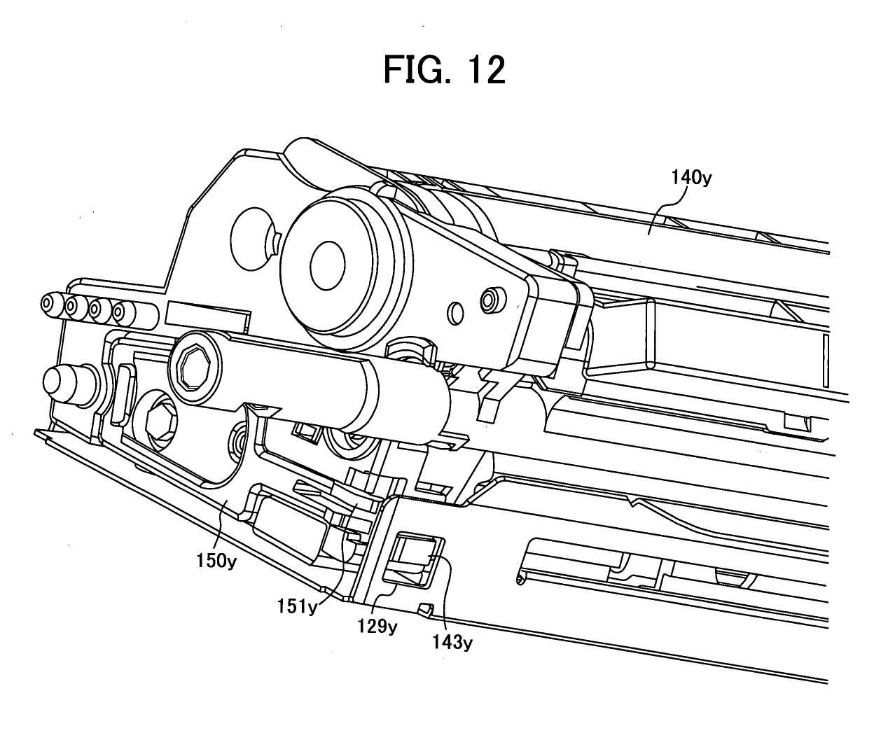

FIGS. 9 and 12 show installation and removal of the process cartridge 140y. In this embodiment of the present invention, the image forming apparatus 100 has the positioning hole 129y and the positioning latch 143y. When the process cartridge 140y is inserted, the positioning latch 143y of the process cartridge 140y fits in the positioning hole 129y of the guide portion 120y by the weight of the process cartridge 140y. Thus, the process cartridge 140y is set to the preliminary position and a locking pressure is applied such that the process cartridge 140y is locked. The process cartridge 140y is then fixed to the precision position by the cover plate 71 as previously described. To release the process cartridge 140y located at the precision position, the lever 150y of the process cartridge 140y is used.

As previously described, the process cartridge 140y has the lever 150y which is arranged at a position close to the positioning latch 143y. The lever 150y is pulled out, and the cam 151y provided at a hinge portion of the lever 150y contacts the regulating member 125y of the guide portion 120y and pushes up the process cartridge 140y. The positioning latch 143y of the process cartridge 140y is disengaged from the positioning hole 129y of the guide portion 120y. The process cartridge 140y is then easily removed by pulling the lever 150y.

FIG. 11 is a perspective view of the process cartridge 140y and FIG. 12 is an enlarged view of a part of the process cartridge 140y. A bottom side of the process cartridge 140y is formed approximately flat so that the process cartridge 140y is smoothly inserted along the guide portion 120y. The convex portion 142y of the process cartridge 140y is arranged at a lower part of the process cartridge 140y to face the regulating member 125y and to be close to the pushup member 128y when the process cartridge 140y is in an operational position.

A process cartridge having a structure of the present invention may easily and smoothly be installed and removed along a guide member eliminating undesirable movements by its own weight.

Similar to the image forming apparatus 1, the image forming apparatus 100 of the present invention includes toner bottles (not shown in FIG. 6) which are separately mounted to the process cartridges 140y, 140c, 140m and 140bk. Namely, the toner bottles may be replaced separately from the process cartridges 140y, 140c, 140m and 140bk when toner needs to be replenished. Also, the process cartridges 140y, 140c, 140m and 140bk may be replaced separately from the toner bottles when a component needs to be replaced.

Obviously, numerous modifications and variations of the present invention are possible in light of the above teachings. It is therefore to be understood that within the scope of the appended claims, the present invention may be practiced otherwise than as specifically described herein.

1. An image forming apparatus, comprising:
a frame;
a plurality of process cartridges; and
a guide mounted to the frame, the guide including a plurality of guide portions having supporting surfaces arranged at predetermined different heights and on which the plurality of process cartridges are detachably placed, and configured to guide the plurality of process cartridges placed on the supporting surfaces along a path between respective first positions and respective second positions.

2. The image forming apparatus according to claim 1, wherein the plurality of process cartridges sequentially form color toner images with toners of predetermined colors different from each other to form a full-color image in each of image forming cycles, each of the plurality of process cartridges comprising:
an image bearing member having a surface on which a latent image for a toner of a corresponding color of the toners of the predetermined colors is formed; and
at least a part of an image forming mechanism integrally mounted with the image bearing member, the image forming mechanism being configured to form a corresponding color toner image based on the latent image formed on the image bearing member.

3. The image forming apparatus according to claim 1, wherein each of the respective first positions is a position at which a corresponding process cartridge of the plurality of process cartridges is placed for installation and is removed for exchange, and each of the respective second positions is a position at which a corresponding process cartridge of the plurality of process cartridges is made operable, the respective second positions being arranged in line with a decrease in vertical height along a direction such that a position of the respective second positions having a lowest vertical height is a position for a process cartridge that lastly forms a toner image among the plurality of process cartridges in one image forming cycle.

4. The image forming apparatus according to claim 1, wherein each of the supporting surfaces of the plurality of guide portions arranged at the predetermined different heights is arranged approximately horizontal.

5. The image forming apparatus according to claim 2, wherein each of the supporting surfaces of the plurality of guide portions arranged at the predetermined different heights is arranged to be inclined relative to a horizontal plane.

6. The image forming apparatus according to claim 5, wherein each of the plurality of guide portions comprises a plurality of supporting members configured to respectively contact at least bottom and side surfaces of a corresponding process cartridge among the plurality of process cartridges to support the corresponding process cartridge.

7. The image forming apparatus according to claim 5, further comprising:
a transfer belt including a belt portion held in contact with the image bearing member of each of the plurality of process cartridges,
wherein the belt portion of the transfer belt and a slope that each of the supporting surfaces of the plurality of guide portions is arranged to be inclined relative to the horizontal plane are parallel to each other.

8. The image forming apparatus according to claim 1, wherein each of the plurality of guide portions includes a regulating member for regulating a displacement movement of a corresponding process cartridge among the plurality of process cartridges in a direction parallel to the supporting surfaces and perpendicular to a moving direction of the corresponding process cartridge during a time the corresponding process cartridge is guided by a corresponding guide portion of the plurality of guide portions.

9. The image forming apparatus according to claim 1, wherein each of the plurality of guide portions includes a regulating member for rejecting placement of an incorrect process cartridge among the plurality of process cartridges.

10. The image forming apparatus according to claim 1, wherein the guide is configured to move in a vertical direction.

11. The image forming apparatus according to claim 1, wherein the plurality of guide portions of the guide are configured to move individually in a vertical direction.

12. The image forming apparatus according to claim 6, wherein the plurality of supporting members included in each of the plurality of guide portions of the guide comprise respective regulators having a predetermined length for regulating movements of a corresponding process cartridge of the plurality of process cartridges in respective directions other than a moving direction of the corresponding process cartridge during a time the corresponding process cartridge is guided.

13. The image forming apparatus according to claim 12, wherein the predetermined length of the respective regulators is shorter than an entire length of the corresponding process cartridge.

14. The image forming apparatus according to claim 2, further comprising:
a cover configured to be moved between opening and closing positions and having a precision positioning shape for fixing the image bearing members of the plurality of process cartridges located at the respective second positions to predetermined precision positions when being moved to the closing position.

15. The image forming apparatus according to claim 12, wherein one of the respective regulators of the plurality of supporting members included in each of the plurality of guide portions of the guide determines a predetermined precision position for the corresponding process cartridge of the plurality of process cartridges in a length direction of the corresponding process cartridge at a corresponding one of the second positions.

16. The image forming apparatus according to claim 15, wherein each of the plurality of process cartridges includes a lever configured to be moved between set and release positions and to set the corresponding process cartridge of the plurality of process cartridges to the predetermined precision position and to release the corresponding process cartridge from the predetermined precision position.

17. The image forming apparatus according to claim 2, further comprising:
a plurality of toner bottles for containing the toners of the predetermined colors different from each other, wherein each of the plurality of toner bottles is configured to be detachable from the image forming apparatus independent from a corresponding process cartridge of the plurality of process cartridges.

18. An image forming apparatus, comprising:
a frame;
a plurality of process cartridges configured to sequentially form color toner images with toners of predetermined colors different from each other to form a full-color image in each image forming cycle; and
means for holding the plurality of process cartridges that are downwardly placed thereto at predetermined different heights and for guiding the plurality of process cartridges along a path between respective first positions to respective second positions.

19. The image forming apparatus according to claim 18, wherein the plurality of process cartridges sequentially form the color toner images with the toners of the predetermined colors different from each other to form a full-color image in each of image forming cycles, each of the plurality of process cartridges comprising:
an image bearing member for bearing a latent image for a toner of a corresponding color of the toners of the predetermined colors; and
an image forming member for forming a corresponding color toner image based on the latent image formed by the image bearing member.

20. The image forming apparatus according to claim 18, wherein each of the respective first positions is a position at which a corresponding process cartridge of the plurality of process cartridges is placed or removed and each of the respective second positions is a position at which a corresponding process cartridge of the plurality of process cartridges is made operable.

21. The image forming apparatus according to claim 18, wherein the means for holding and for guiding includes guiding supporting surfaces arranged approximately horizontal for supporting the plurality of process cartridges.

22. The image forming apparatus according to claim 18, wherein the means for holding and for guiding includes supporting surfaces arranged to be inclined relative to a horizontal plane for supporting the plurality of process cartridges.

23. The image forming apparatus according to claim 22, wherein the means for holding and for guiding contacts at least bottom and side surfaces of a corresponding process cartridge among the plurality of process cartridges to support the corresponding process cartridge.

24. The image forming apparatus according to claim 22, further comprising:
means for superimposing the color toner images formed by the plurality of process cartridges at a plurality of superimposing points,
wherein a plane connecting the plurality of superimposing points provided by the means for superimposing and a slope that each of the supporting surfaces of the means for holding and guiding is arranged to be inclined relative to the horizontal plane are parallel to each other.

25. The image forming apparatus according to claim 21, wherein the means for holding and for guiding includes a plurality of regulating members each for regulating a displacement movement of a corresponding process cartridge among the plurality of process cartridges in a direction parallel to the supporting surfaces and perpendicular to a moving direction of the corresponding process cartridge during a time the corresponding process cartridge is guided by the means for holding and for guiding.

26. The image forming apparatus according to claim 18, wherein the means for holding and for guiding includes a plurality of regulating members each for rejecting placement of an incorrect process cartridge among the plurality of process cartridges.

27. The image forming apparatus according to claim 24, wherein the means for holding and for guiding moves the plurality of process cartridges in contact with the image superimposing means in a direction away from the means for superimposing and perpendicular to a plane of the image superimposing points.

28. The image forming apparatus according to claim 27, wherein the means for holding and for guiding moves each of the plurality of process cartridges individually.

29. The image forming apparatus according to claim 22, wherein the means for holding and for guiding regulates movements of a corresponding process cartridge of the plurality of process cartridges for a predetermined distance in respective directions other than a moving direction of the corresponding process cartridge during a time the means for holding and for guiding guides the corresponding process cartridge.

30. The image forming apparatus according to claim 29, wherein the predetermined distance is shorter than an entire length of the corresponding process cartridge.

31. The image forming apparatus according to claim 18, further comprising:
means for enclosing and fixing the plurality of process cartridges at predetermined precision positions.

32. The image forming apparatus according to claim 29, wherein the means for holding and for guiding determines a predetermined precision position for a corresponding process cartridge of the plurality of process cartridges in a length direction of the corresponding process cartridge at a corresponding one of the second positions.

33. The image forming apparatus according to claim 31, wherein each of the plurality of process cartridges includes a lever configured to be moved between set and release positions and to set a corresponding process cartridge of the plurality of process cartridges to the predetermined precision position and to release the corresponding process cartridge from the predetermined precision position.

34. The image forming apparatus according to claim 18, further comprising:
a plurality of toner bottles for containing the toners of the predetermined colors different from each other, wherein each of the plurality of toner bottles is configured to be detachable from the image forming apparatus independent from a corresponding process cartridge of the plurality of process cartridges.

35. A method of a process cartridge loading arrangement for an image forming apparatus, comprising:
providing a guide including a plurality of guide portions having supporting surfaces arranged at predetermined different heights;
placing a plurality of process cartridges detachably on the supporting surfaces of the plurality of guide portions of the guide; and
guiding the plurality of process cartridges placed on the supporting surfaces from respective first positions to respective second positions.

36. The method according to claim 35, wherein the plurality of process cartridges sequentially form color toner images with toners of predetermined colors different from each other to form a full-color image in each of image forming cycles, each of the plurality of process cartridges comprising:
an image bearing member having a surface on which a latent image for a toner of a corresponding color of the toners of the predetermined colors is formed; and
at least a part of an image forming mechanism integrally mounted with the image bearing member, the image forming mechanism being configured to form a corresponding color toner image based on the latent image formed on the image bearing member.

37. The method according to claim 35, wherein each of the respective first positions is a position at which a corresponding process cartridge of the plurality of process cartridges is placed for installation and is removed for exchange, and each of the respective second positions is a position at which a corresponding process cartridge of the plurality of process cartridges is made operable, the respective second positions being arranged in line with a decrease in vertical height along a direction such that a position of the respective second positions having a lowest vertical height is a position for a process cartridge that lastly forms a toner image among the plurality of process cartridges in one image forming cycle.

38. The method according to claim 35, wherein each of the supporting surfaces of the plurality of guide portions arranged at the predetermined different heights is arranged approximately horizontal.

39. The method according to claim 35, wherein each of the supporting surfaces of the plurality of guide portions arranged at the predetermined different heights is arranged to be inclined relative to a horizontal plane.

40. The method according to claim 39, wherein each of the plurality of guide portions comprises a plurality of supporting members configured to respectively contact at least bottom and side surfaces of a corresponding process cartridge of the plurality of process cartridges to support the corresponding process cartridge.

41. The method according to claim 39, further comprising:
arranging a transfer belt such that a belt portion of the transfer belt contacts image bearing members of the plurality of process cartridges and is parallel to a slope at which each of the supporting surfaces of the plurality of guide portions is arranged.

42. The method according to claim 35, wherein each of the plurality of guide portions includes a regulating member for regulating a displacement movement of a corresponding process cartridge among the plurality of process cartridges in a direction parallel to the supporting surfaces and perpendicular to a moving direction of the corresponding process cartridge during a time the corresponding process cartridge is guided by a corresponding guide portion of the plurality of guide portions.

43. The method according to claim 35, wherein each of the plurality of guide portions includes a regulating member for rejecting placement of an incorrect process cartridge among the plurality of process cartridges.

44. The method according to claim 35, wherein the guide is configured to move in a vertical direction.

45. The method according to claim 35, wherein the plurality of guide portions of the guide are configured to move individually in a vertical direction.

46. The method according to claim 39, wherein the plurality of supporting members included in each of the plurality of guide portions of the guide comprise respective regulators having a predetermined length for regulating movements of a corresponding process cartridge of the plurality of process cartridges in respective directions other than a moving direction of the corresponding process cartridge during a time a corresponding guide portion of the plurality of guide portions guides the corresponding process cartridge.

47. The method according to claim 46, wherein the predetermined length of the respective regulators is shorter than an entire length of the corresponding process cartridge.

48. The method according to claim 35, further comprising:
moving a cover to a closing position to fix image bearing members of the plurality of process cartridges located at the respective second positions to predetermined precision positions.

49. The method according to claim 40, wherein one of the respective regulators of the plurality of supporting members included in each of the plurality of guide portions of the guide determines a predetermined precision position for a corresponding process cartridge of the plurality of process cartridges in a length direction of the corresponding process cartridge at a corresponding one of the respective second positions.

50. The method according to claim 49, wherein each of the plurality of process cartridges includes a lever configured to be moved between set and release positions and to set a corresponding process cartridge of the plurality of process cartridges to the predetermined precision position and to release the corresponding process cartridge from the predetermined precision position.

51. The method according to claim 36, further comprising:
providing a plurality of toner bottles for containing the toners of the predetermined colors different from each other,
wherein each of the plurality of toner bottles is configured to be detachable from the image forming apparatus independent from a corresponding process cartridge of the plurality of process cartridges.

52. A detachable process cartridge for an image forming apparatus, comprising:
a bottom having an approximately plane surface held in contact by a supporting member of the image forming apparatus; and
a side surface comprising an engaging portion configured to engage with a guide of the image forming apparatus.

53. The detachable process cartridge according to claim 52, wherein the side surface further comprises a positioning portion configured to determine a precision position for the detachable process cartridge relative to the image forming apparatus.
